(19) United States
(12) Patent Application Publication
(10) Pub. No.: US 2009/0315994 A1
(43) Pub. Date: Dec. 24, 2009

(54) SECURITY CAMERA WITH MAGNETIC ADJUSTOR

(76) Inventor: Yi-Jen Cheng, Taichung (TW)

Correspondence Address: Hershkovitz & Associates, LLC, 2845 Duke Street, Alexandria, VA, 22314, US

(21) Appl. No.: 12/132,584

(22) Filed: Jun. 3, 2008

(51) Int. Cl. H04N 7/18

(52) U.S. Cl. 348/152; 348/E07.085

(57) ABSTRACT

A security camera with magnetic adjustor has a camera body and a front cap assembly. The camera body has a case, an optoelectronical module and at least one magnetic adjustor. The optoelectronical module is coaxially mounted in the case and has a camera lens. The at least one magnetic adjustor is a telescopic rod, is mounted radially on the camera lens and has a distal end and an inner magnet being mounted in the distal end. The front cap assembly has at least one adjustment guide. The at least one adjustment guide is rotatably mounted on the case and has an outer magnet corresponding to the inner magnet of a corresponding magnetic adjustor. A size of the optoelectronical module is changeable for lower production costs since the magnetic adjustors are telescopically adaptable to different camera cases.

### BACKGROUND OF THE INVENTION

1. Field of Invention

The present invention relates to security cameras, and more particularly to security cameras with a magnetic adjustor.

2. Description of the Related Art

Security cameras are commonly implemented for crime prevention and property protection for homes, governmental, commercial and industrial buildings as well as outdoors in streets, outside entrances, in high risk areas, or large areas such as ports, airports, bus or train stations and the like. A conventional security camera always has an adjustment guide that is integrally mounted on a lens for adjusting focus and aperture size of the security camera. When the security camera is installed outside, the security camera and the adjustment guide is made water resistant, normally by sealed casings.

With reference to FIGS. 6A and 6B, an outdoor security camera in accordance with an invention patent of USA (U.S. Pat. No. 7,066,663) has a case (91), an optoelectronical module (92), two inner adjustors (93), a guiding brace (94) and two outer adjustment guides (95).

The case (91) has an inner annular surface and an outer annular surface. The optoelectronical module (92) is mounted coaxially in the case (91) and has a focus controller and an aperture controller. The focus controller and the aperture controller are rotatably mounted on the optoelectronical module (92) and are moved to adjust the focus and the aperture size of the optoelectronical module (92). The two interior adjustors (93) are rod-like and each has a proximal end and a distal end. The proximal ends of the interior adjustors (93) are respectively mounted securely on the focus and the aperture controllers. The distal end of each interior adjustor (93) radially extends to the interior annular surface of the case (91) and has a magnet securely mounted thereon.

The guiding brace (94) is an arced sheet corresponding to and being mounted on the outer annular surface of the case (91) and forms a gap with the case (91) after being mounted on the case (91). The guiding brace (94) further has two guiding slots (942) formed circumferentially therethrough. Each one of the guiding slots (942) corresponds to a route of one of the distal ends of the interior adjustors (93).

The adjustment guides (95) are respectively and slidably mounted in the guiding slots (942) and each has a magnet corresponding to the magnet of one of the interior adjustors (93), where the magnet of each adjustment guide (95) is magnetically attracted by the magnet of corresponding interior adjustor (93).

When a person wants to adjust the focus or the aperture of the optoelectronical module (92), they can just move the adjustment guides (95) along the guiding slots (942) instead of opening the case (91) to adjust the focus controller or the aperture directly. Hence, the described outdoor security camera is easy to use and is suitable to be installed outside since the optoelectronical module (92) is protected by the case (91).

However, the outdoor security camera still has some shortcomings. For instance, choosing the optoelectronical module (92) is limited in considering the size since the sizes of the case (91) and the interior adjustors (93) are fixed. If the diameter of the optoelectronical module (92) are changed (smaller or larger), the adjustment guides (95) will no longer smoothly adjust the position of the interior adjustors (93) since the movement of each interior adjustor (93) will be resisted by friction with the inner annular surface of the case (91) or be less attracted with the adjustment guides (95).

Furthermore, ranges of adjusting the focus and the aperture size of the optoelectronical module (92) are limited since movement of the adjustment guides (95) is to lengths of the guiding slots (942).

The present invention provides a security camera with magnetic adjustor to obviate or mitigate the shortcomings of the conventional outdoor security camera.

### SUMMARY OF THE INVENTION

The primary objective of the present invention is to provide a security camera with magnetic adjustor to improve flexibility of choosing sizes of an optoelectronical module to be used and also to improve adjustment ranges of the focus and the aperture.

The security camera with magnetic adjustor has a camera body and a front cap assembly. The camera body has a case, an optoelectronical module and at least one magnetic adjustor. The optoelectronical module is coaxially mounted in the case and has a camera lens. The at least one magnetic adjustor is a telescopic rod, is mounted radially on camera lens and has a distal end and an inner magnet being mounted in the distal end. The front cap assembly has at least one adjustment guide. The at least one adjustment guide is rotatably mounted on the case and has an outer magnet corresponding to the inner magnet of one of a corresponding magnetic adjustor. A size of the optoelectronical module is changeable for lower production costs since the magnetic adjustors are telescopically adaptable to different camera cases.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a security camera with a magnetic adjustor in accordance with the present invention;

FIG. 2 is a partially exploded perspective view of the security camera with magnetic adjustor in FIG. 1;

FIGS. 3A and 3B are enlarged view in partial section of two security cameras having different diameters in accordance with the present invention;

FIG. 4 is an operational front view of the security camera with magnetic adjustor in FIG. 1;

FIG. 5 is a partially exploded perspective view of a second embodiment of the security camera in accordance with the present invention;

FIG. 6A is a partially exploded perspective view of an outdoor security camera in accordance with the prior art; and

FIG. 6B is an operational front view of the outdoor security camera in FIG. 6A.

### DETAILED DESCRIPTION OF THE INVENTION

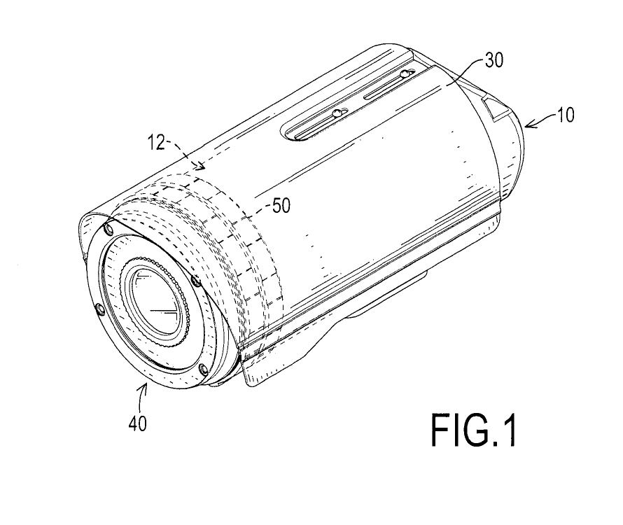

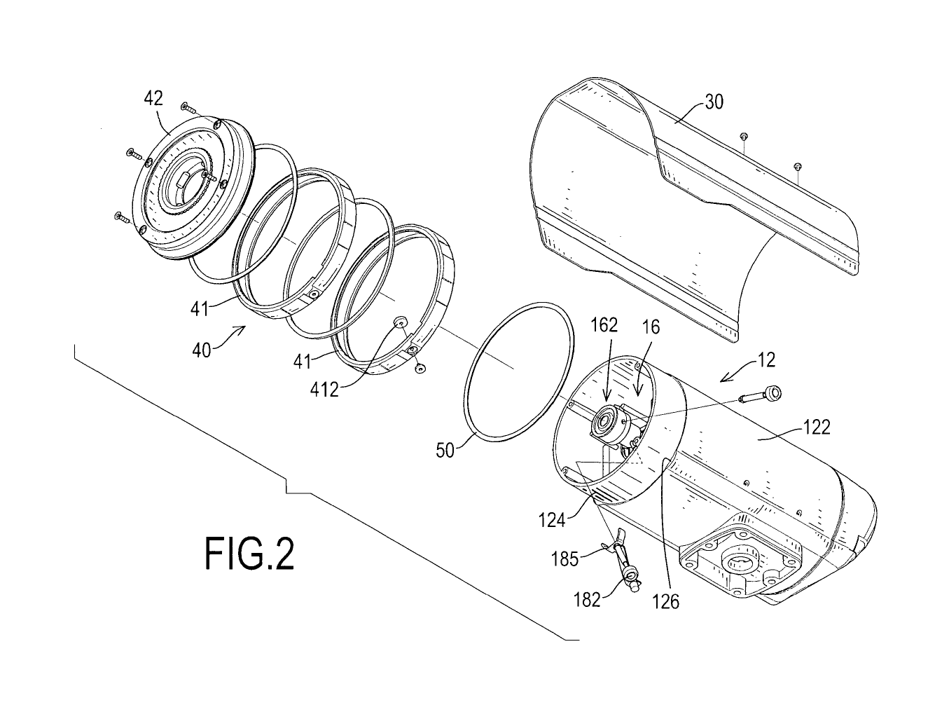

With reference to FIGS. 1 and 2, a security camera with magnetic adjustor in accordance with the present invention comprises a camera body (10), an optional weather resistant cover (30), a front cap assembly (40) and at least one optional spacer (50).

The camera body (10) has a case (12), an optoelectronical module (16) and at least one magnetic adjustor (18).

The case (12) is tubular, may be cylindrical, polyhedral or the like and has an inner surface, a main section (122), a mounting section (124) and a stop edge (126).

The mounting section (124) is coaxially formed on the main section (122), may be thinner than the main section (122) and has an outer annular surface and an opening.

The stop edge (126) is formed between the main section (122) and the mounting section (124) and may be a protrusion rib between the main section (122) and the mounting section (124) or may be formed by the mounting section (124) being thinner than the main section (122). The optoelectronical module (16) is capable of successively capturing light to generate a video image, is mounted securely inside the case (12) and has a camera lens (162) being disposed centrally in the mounting section (124). The camera lens (162) has a focus controller and an aperture controller that are independently mounted rotatably on the camera lens (162) and being selectively rotated to achieve focus. When the focus controller and the aperture controller are rotated along the camera lens (162), a focus and an aperture size are adjusted.

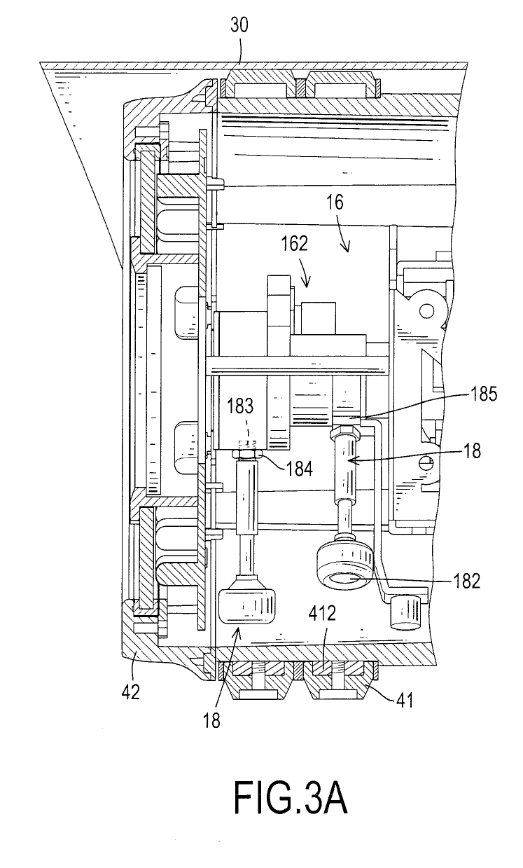

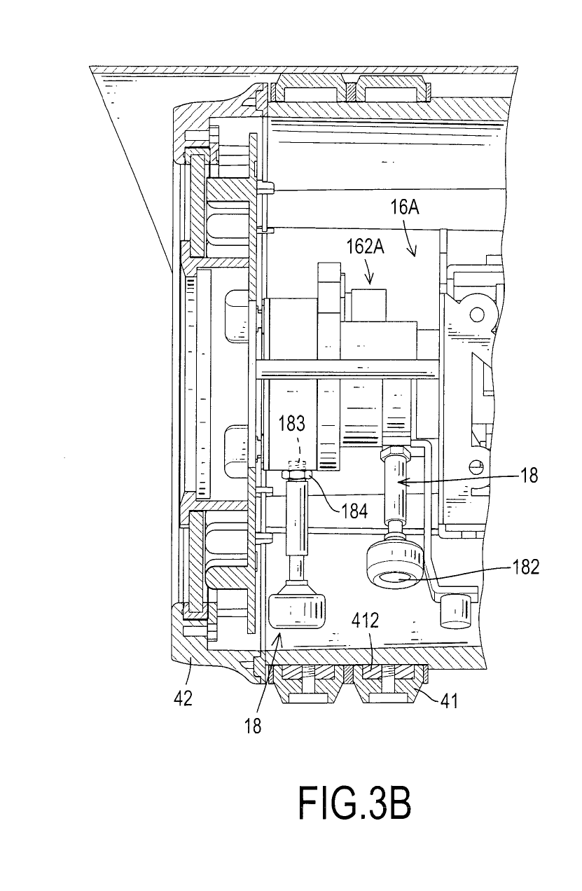

With further reference to FIG. 3A, the at least one magnetic adjustor (18) is a telescopic rod and has a proximal end, a distal end, an inner magnet (182), an optional threaded head (183), an optional nut (184) and an optional holder (185). In the preferred embodiment of the present invention, two magnetic adjustors (18) are detachably and respectively mounted radially on the focus controller and the aperture controller of the optoelectronical module (16).

The inner magnet (182) is mounted in the distal end of each magnetic adjustor (18).

The threaded head (183) is coaxially formed on the proximal end of the magnetic adjustor (18) and is radially screwed onto the camera lens (162), maybe onto the focus controller or the aperture controller using the threaded head (183) and may be adapted to be connected radially to the camera lens (162).

The nut (184) corresponds to and is moveably mounted on the threaded head (183) and pressing the camera lens (162) to securely hold the magnetic adjustor radially on the camera lens (162). When the threaded head (183) is screwed onto the focus controller or the aperture controller, the nut (184) is moved toward the focus or the aperture controller until the nut (184) presses against the focus or the aperture controller to more securely hold the magnetic adjustor (18) radially on the focus or the aperture controller.

The holder (185) may be an arced bracket or an annular bracket and is securely mounted on the proximal end of the corresponding magnetic adjustor (18), may be using the threaded head (183) and nut (184). The holder (185) corresponds to and is detachably mounted on the camera lens (162), maybe on the focus controller or the aperture controller.

In the preferred embodiment of the present invention, the proximal end of the one of the magnetic adjustors (18) has the threaded head (183) and the nut (184) screwed onto the focus controller directly. The proximal end of the other one of the magnetic adjustors (18) further has one holder (185) being an arced bracket being mounted the-eon, corresponding to and being securely held on the aperture of the camera lens (162).

The weather resistant cover (30) is an arced sheet and has an inner surface corresponding to and being mounted on the case (12) to increase contrast ratio and prevent precipitation or solar damage to the camera body (10).

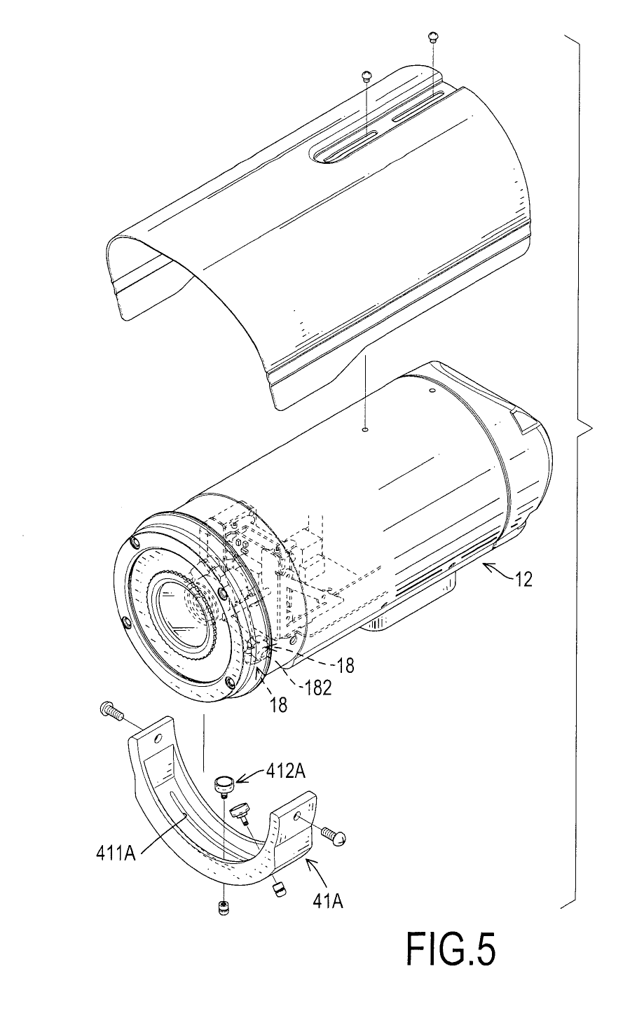

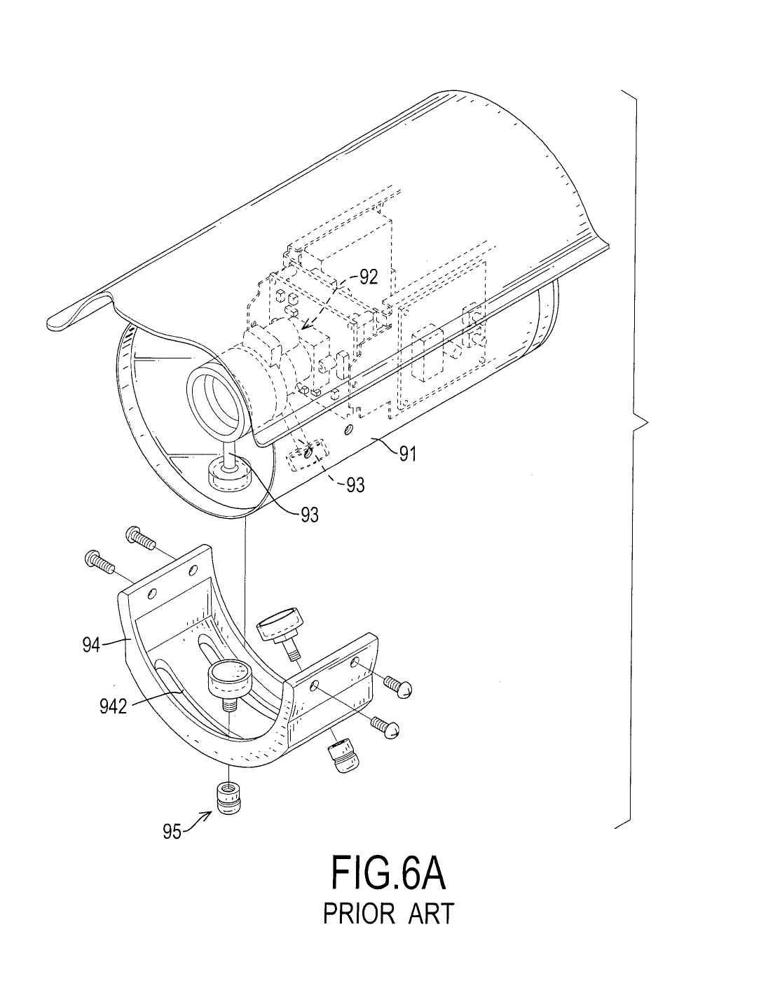

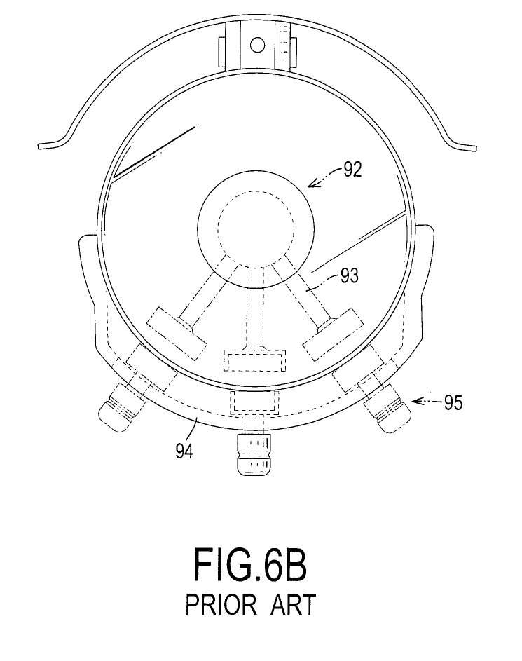

With further reference to FIG. 5, the front cap assembly (40) is detachably mounted coaxially on the opening of the mounting section (124) to seal and provide protection to the optoelectronical module (16) inside the case (12) and has at least one adjustment guide (41, 41A) and a front cap (42).

Each one of the at least one adjustment guide (41, 41A) is mounted on the outer annular surface of the mounting section (124), is disposed corresponding to the at least one magnetic adjustor (18) and each has an outer magnet (412, 412A) being mounted therein. The outer magnet (412, 412A) corresponds to and attracts a corresponding inner magnet (182) to rotate and adjust the focus or aperture of the camera lens (162).

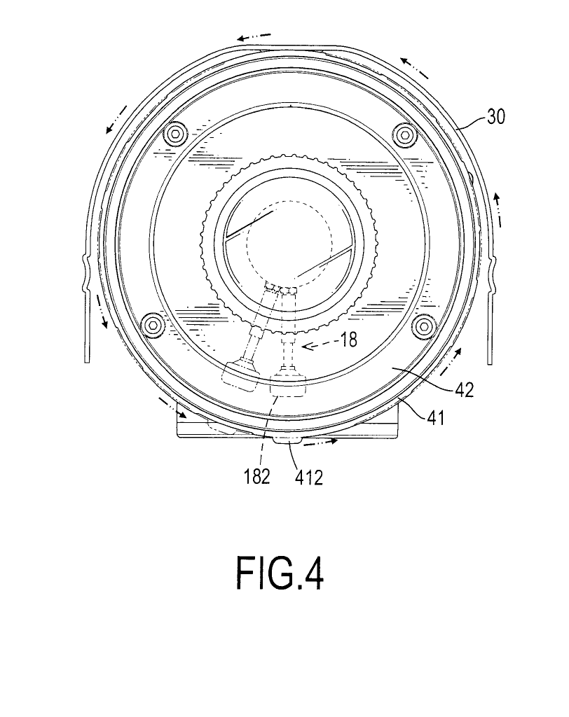

With further reference to FIG. 4, the at least one adjustment guide (41) is a ring, corresponds to one magnetic adjustor (18). Two adjustment guides (41) may be successively mounted on the outer annular surface of the mounting section (124) and disposed corresponding to one magnetic adjustor. The aperture and the focus of the optoelectronical module (16) may be easily adjusted in a very wide range by rotating the adjustment guides (41) around the mounting section (124).

The adjustment guide (41A) may be a bracket mounted on the outer annular surface of the mounting section (124) and the adjustment guide (41A) comprises an inner surface, an outer surface, two guiding slots (411A), a guiding recess and two outer magnets (412A). The guiding recess is formed in the inner surface of the adjustment guide (41A) and defines a gap between the adjustment guide (41A) and the outer annular surface of the mounting section (124). The guiding slots (411A) are longitudinally formed parallelly in the outer surface of the adjustment guide (41A) corresponding to paths of the inner magnets (182) of the magnetic adjustors (18). The outer magnets (412A) are slidably mounted respectively in the two guiding slots (411A) and each has an outer end extending through a corresponding guiding slot (411A) and an adjusting nut mounted on the outer end of the outer magnet (412A).

The front cap (42) is partially transparent, corresponds to and is mounted on the opening of the mounting section (124). The front cap (42) may be coaxially screwed onto mounting section (124) to protect the optoelectronical module (16) and pushes the adjustment guide (41) against the stop edge (126).

The at least one spacer (50) is a ring, corresponds to and is detachably mounted on the outer annular surface of the mounting section (124) between the stop edge (126) and the front cap (42), thereby allowing a variety of optoelectronical modules (16) of different lengths to be mounted into the case (12) by adjusting width of the spacer (50).

Furthermore, in the preferred embodiment, optoelectronical modules (16) having different camera lenses (162) with different diameters are also capable of being mounted in a same size case (12) without interference with the case (12) nor suffering from poor attraction with the adjustment guides (41). With further reference to FIG. 3B, especially compared to FIG. 3A, two optoelectronical modules (16, 16A) having camera lenses (162, 162A) of different diameters are mounted in a same size case (12). Manufactures need only adjust the magnetic adjustors (18) to suitable lengths during assembly to ensure good attraction, which is done simply and securely.

As described above, the embodiments of present invention allow a variety of optoelectronical modules (16) of different sizes (including total length and diameter) to be selectively mounted into the same case (12). Costs of manufacturing are also significantly reduced due to economy of scale in producing a same size case (12) that is capable of mounting optoelectronical modules (16) with different sizes.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A security camera comprising
a camera body having
a case being tubular and having
a main section;
a mounting section being coaxially formed on the main section and having
an outer annular surface; and
an opening; and
a stop edge being formed between the main section and the mounting section;
an optoelectronical module being capable of successively capturing light to generate a video image, being mounted securely inside the case and having a camera lens being disposed centrally in the mounting section; and
at least one magnetic adjustor being a telescopic rod and each one of the at least one magnetic adjustor having
a proximal end being securely and radially mounted on the camera lens;
a distal end; and
an inner magnet being mounted in the distal end of the magnetic adjustor; and
a front cap assembly being detachably mounted coaxially on the opening of the mounting section to seal and provide protection of the optoelectronical module inside the case and having
at least one adjustment guide, each one of the at least one adjustment guide being a ring, being rotatably mounted on the outer annular surface of the mounting section, being disposed corresponding to one of the at least one magnetic adjustor and having an outer magnet being mounted in the adjustment guide and corresponding to and attracting a corresponding inner magnet; and
a front cap corresponding to and being mounted on the opening of the mounting section and protecting the optoelectronical module and pushing the adjustment guide against the stop edge.

2. The security camera as claimed in claim 1 further having
at least one spacer being a ring, corresponding to and being detachably mounted on the outer annular surface of the mounting section between the stop edge and front cap, wherein
each one of the at least one adjustment guide is a ring corresponding to one of the at least one magnetic adjustor.

3. The security camera as claimed in claim 1, wherein each one of the at least one magnetic adjustor has
a threaded head being coaxially formed on the proximal end of the magnetic adjustor and being radially screwed onto the camera lens; and
a nut corresponding to and being moveably mounted on the threaded head and pressing the camera lens to securely hold the magnetic adjustor radially on the camera lens.

4. The security camera as claimed in claim 2, wherein each one of the at least one magnetic adjustor has
a threaded head being coaxially formed on the proximal end of the magnetic adjustor and being radially screwed onto the camera lens; and
a nut corresponding to and being moveably mounted on the threaded head and pressing the camera lens to securely hold the magnetic adjustor radially on the camera lens.

5. The security camera as claimed in claim 3, wherein each one of the at least one magnetic adjustor further has a holder being an arced bracket, corresponding to and being detachably mounted on the camera lens and being securely mounted on the proximal end of the magnetic adjustor using the threaded head and the nut.

6. The security camera as claimed in claim 4, wherein each one of the at least one magnetic adjustor further has a holder being an arced bracket, corresponding to and being detachably mounted on the camera lens and being securely mounted on the magnetic adjustor using the threaded head and the nut.

7. The security camera as claimed in claim 5 wherein
the camera lens has a focus controller and an aperture controller being independently mounted rotatably on the camera lens and being selectively rotated to achieve focus;
the security camera has two magnetic adjustors being respectively mounted on the focus controller and the aperture controller; and
the front cap assembly has two adjustment guides being successively mounted on the outer annular surface of the mounting section, each adjustment guide being disposed corresponding to one of the magnetic adjustors.

8. The security camera as claimed in claim 6 wherein
the camera lens has a focus controller and an aperture controller being independently mounted rotatably on the camera lens and being selectively rotated to achieve focus;
the security camera has two magnetic adjustors being respectively mounted on the focus controller and the aperture controller; and
the front cap assembly has two adjustment guides being successively mounted on the outer annular surface of the mounting section, each adjustment guide being disposed corresponding to one of the magnetic adjustors.

9. In a security camera comprising a camera lens and a magnetic adjustor, wherein the improvements comprise the magnetic adjustor being a telescopic rod and comprising
a proximal end corresponding to and being selectively mounted securely on a camera lens of the security camera;
a distal end; and
an inner magnet being mounted in the distal end.

10. The security cameras as claimed in claim 9, wherein the magnetic adjustor further has
a threaded head being coaxially formed on the proximal end and being connected radially to the camera lens; and
a nut corresponding to and being moveably mounted on the threaded head and pressing the camera lens to securely hold the magnetic adjustor radially on the camera lens.

11. The security camera as claimed in claim 10, wherein the magnetic adjustor further has a holder being an arced bracket, corresponding to and being securely and detachably mounted on the camera lens and being securely mounted on the proximal end of the magnetic adjustor using the threaded head and the nut.
